(19) United States
(12) Patent Application Publication
(10) Pub. No.: US 2003/0142408 A1
(43) Pub. Date: Jul. 31, 2003

(54) Original light source or light source adopting a method to modulate light intensity with a stack of gain-flattening filters

(75) Inventors: Cheng-Chung Lee, Tainan (TW); Ya-Ping Li, Tainan (TW); Sheng-Hui Chen, Tainan (TW)

Correspondence Address: BRUCE H. TROXELL, Suite 1404, 5205 Leesburg Pike, Falls Church, VA, 22041, US

(73) Assignee: Cheng-Chung LEE

(21) Appl. No.: 10/058,500

(22) Filed: Jan. 30, 2002

(51) Int. Cl. G02B 27/00; G02B 5/28

(52) U.S. Cl. 359/590; 359/577

(57) ABSTRACT

An original light source or a light source adopting a method to modulate the waveform intensity with a stack of gain-flattening filters includes the following procedures: preparing a stack of gain-flattening filters made of more than two or three aligned single filters, each is made by stacking on a substrate or on both sides of a substrate with several layers of optical films having different refractive indexes; followed by modulating the waveform intensity with a stack of gain-flattening filters installed at the emitting end of the original light source or light source, wherein the angle of each single filter can be adjusted to change the spectrum of a whole set of filters so that the waveform intensity of the original light source or light source is changeable when the emitted original light source or light source is modulated with a stack of gain-flattening filters.

### FIELD OF THE INVENTION

The present invention relates to a method to modulate the light intensity of the original light source or light source used in optical communication with a stack of gain-flattening filters, which in further use provides operational convenience as an application benefit after the original light source or light source is modulated and flattened.

### BACKGROUND OF THE INVENTION

In general, the original light source or the light source has different intensity for different wavelength. This is inconvenient for use. Erbium-doped fiber amplifier (EDFA) used in optical communication is an example, which shows different intensity for different wavelength. As shown in FIG. 1, the irregular curve in the EDFA spectrum indicates different intensity for different band. There are many solutions for this problem. The frequently used method is to add a gain-flattening filter that enables equivalent light intensity within the band adopted.

At present, such filter is made by coating films in different thickness on a substrate with vacuum coating technology. The layer p and the layer q for the filter in FIG. 2 are optical thin films of different refractive indexes and different thickness. After coating, the spectrum (as shown in FIG. 3) and the EDFA spectrum can be modulated to form a spectrum as shown in FIG. 4 that has been subject to gain-flattening treatment for the convenience of further application. Nevertheless, such a film stack has a complicated structure and its wavelength can not be changed after coating. Its error allowance for film thickness is low. Besides the technical requirements in its manufacturing process is high while the yield is low. In addition, the total film thickness is large. The film stress is so high that, in an even worse condition, delamination may occur. Meanwhile, the spectrum may deform. Therefore, the applicability of such single filter of multi-layered coated films is limited by the unchangeable wavelength associated with the multi-layered films, high technical requirements in its manufacturing process and low yield. So it does not possess the economical benefit for commercial production.

### SUMMARY OF THE INVENTION

In view of this, aiming at meeting the demand of gain-flattening for the original light source or the light source used in optical communication, the inventor of the present invention proposed a method to design the gain-flattening filter into an assembly containing no less than two pieces, called stack of gain flattening filters (SGF). This method has an advantage of structural regularity in film, formed with thickness of one fourth of the wavelength (as shown in FIG. 5) or primarily one fourth of the wavelength plus few layers with thickness of non-one-fourth of the wavelength. Hence, in the vacuum coating process, the wavelength formation parameter in a fixed number instead of a variable number is used as reference to control the film thickness. This relatively provides an easy control in manufacturing process and a significant increase in yield. In addition, such a formation mode of thin film on one side or double sides of a single piece causes less film stress. One or two pieces of such filters can be fine-tuned to approach the required filter waveform and perfection of gain flattening.

The method to modulate the light intensity of the original light source or the light source with a stack of gain-flattening filters is explained in details with illustrations as follows:

### BRIEF DESCRIPTION OF THE DRAWINGS

FIG. 1 is the spectrum of an Erbium-doped fiber amplifier (EDFA).

FIG. 2 is a cross-sectional illustration for the use of a traditional vacuum coating technology to coat film stacks of different thickness on a substrate.

FIG. 3 is the spectrum for the traditional filter in FIG. 2.

FIG. 4 is the spectrum obtained after an Erbium-doped fiber amplifier is modulated and flattened.

FIG. 5 is the spectrum for a filter with thickness of one fourth of the wavelength.

FIG. 6 is the illustration for an embodiment in the present invention that two film stacks A and B are respectively coated on two different substrates to align and form a double-piece double-layered gain-flattening filter.

FIG. 7 is the illustration for an embodiment in the present invention that three film stacks A, B and C are respectively coated on three different substrates to align and form a stack of gain-flattening filters.

FIG. 8 is the illustration for an embodiment in the present invention that two film stacks A and B are coated on the two sides of the same substrate to align and form a single-piece double-layered gain-flattening filter.

FIG. 9 is the spectrum for an embodiment in the present invention that two film stacks A and B are combined to form a double-layered gain-flattening filter.

FIG. 10 is the spectrum indicating a target curve for an embodiment related to a stack of gain-flattening filters in the present invention.

FIG. 11 is the spectrum for an embodiment in the present invention that three film stacks A, B and C are combined to form a triple-piece gain-flattening filter.

### DETAILED DESCRIPTION OF THE INVENTION

The method to modulate the light intensity of the original light source or the light source with a stack of gain-flattening filters contains the following procedures:

prepare a stack of gain-flattening filters, which is made of more than two or three aligned single filters, each of which is made by stacking on a substrate with several layers of optical thin films having different refractive indexes or stacking on both sides of a substrate with several different stacked films that are made of the optical thin films having different refractive indexes.

the stack of gain-flattening filters are placed at the emitting end of the original light source or the light source to modulate the waveform intensity, and besides, the angle of any single filter can be adjusted to change the spectrum of the whole set of filters so that the waveform intensity of the original light source or the light source is changeable or flattened when the emitted original light source or the light source is modulated with the stack of gain-flattening filters.

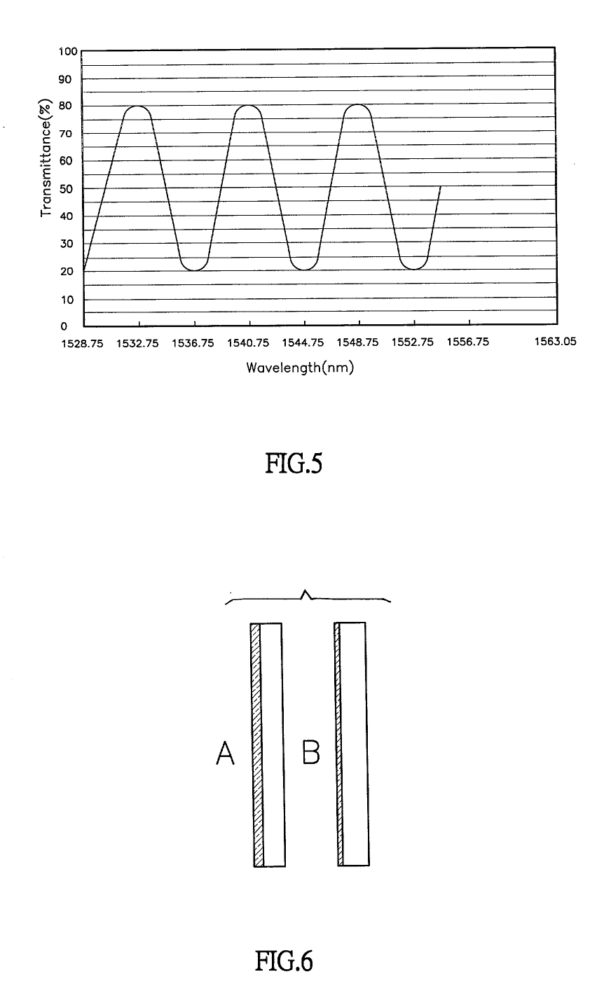

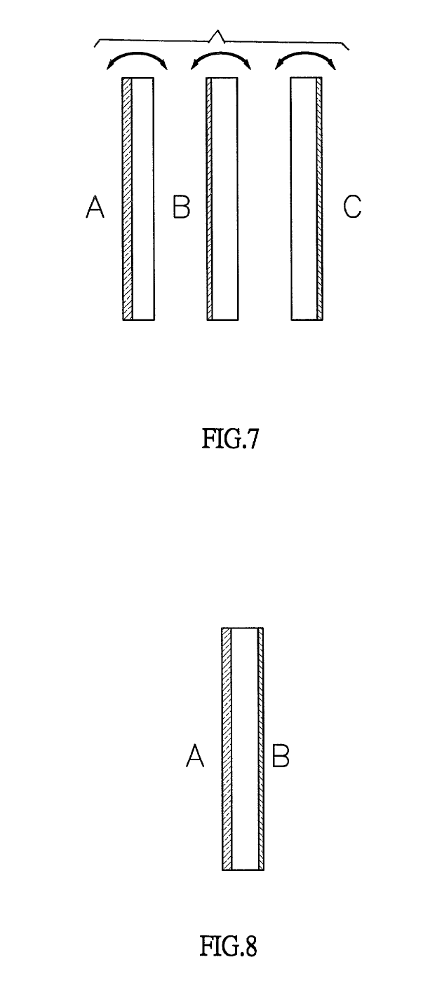

First, take EDFA as the example of an embodiment of the present invention. EDFA is an indispensable light source for Wavelength Division Multiplex (WDM) wave division and multi-function and long-distance fiber-optics communications. But since the light intensity for each band is different, inconvenience is caused in use. To facilitate the afterward application in optical communication by gain flattening, a stack of gain-flattening filters (SGF) was proposed to modulate the light intensity. So called stack of filters means an assembly of two, three or more filters, each of which is coated with different film stack (as shown in FIG. 6 or FIG. 7) or both sides of the substrate of which are coated with different film stacks (as shown in FIG. 8). Each of the above-mentioned film stacks is basically regular structure with thickness of one fourth of the wavelength or is structure mainly with thickness of one fourth of the wavelength plus few layers with thickness of non-one-fourth of the wavelength. As a result, the manufacturing process is simple, the error allowance for film thickness is relatively large and the yield is increased.

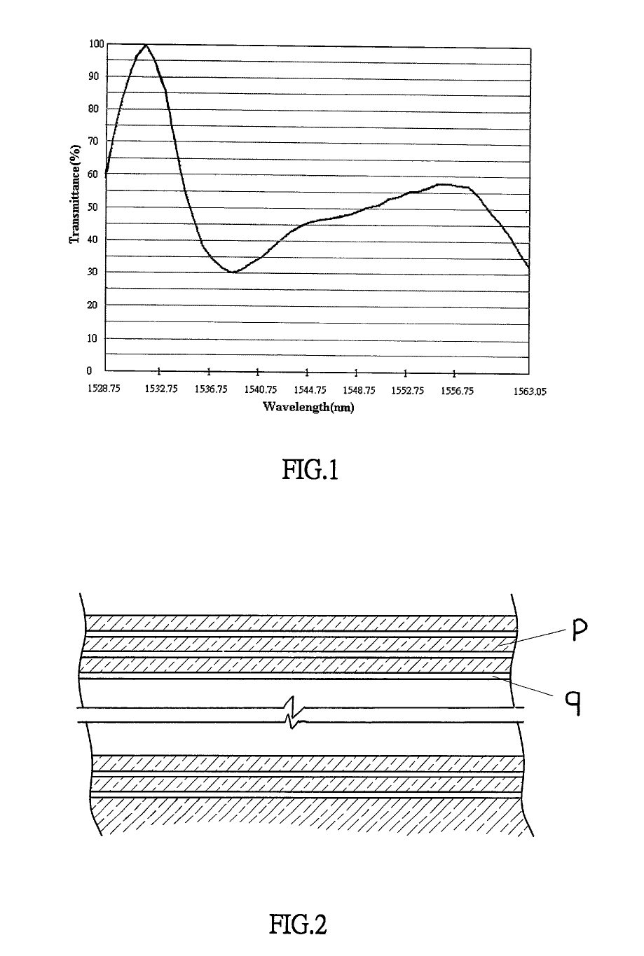

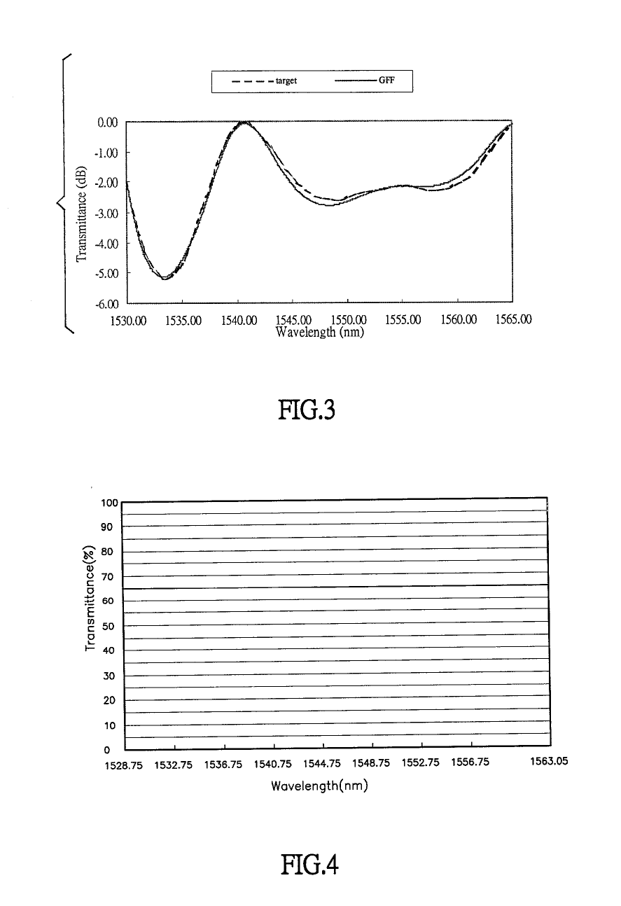

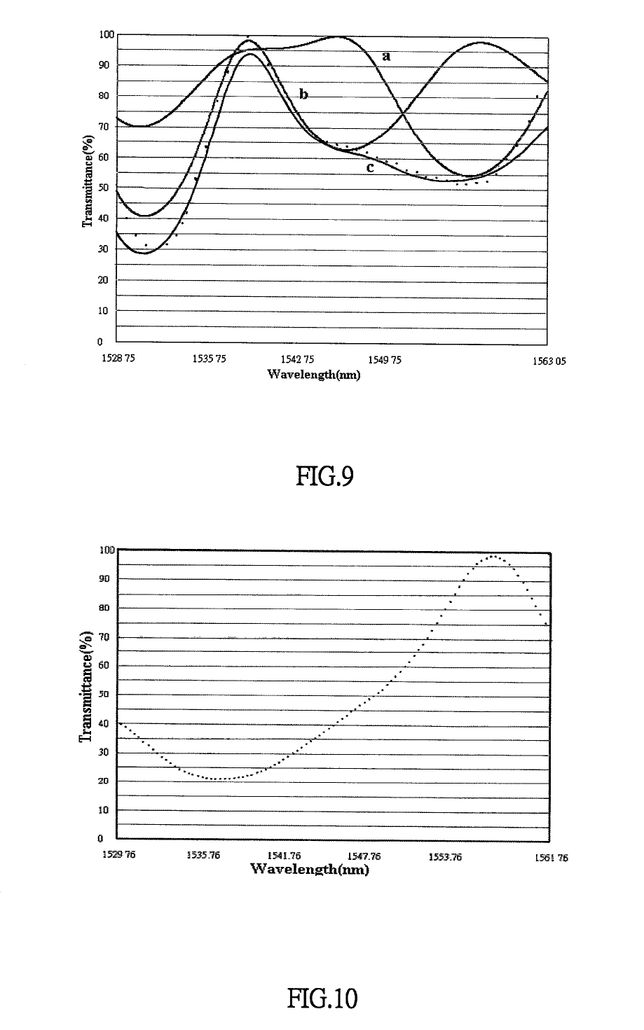

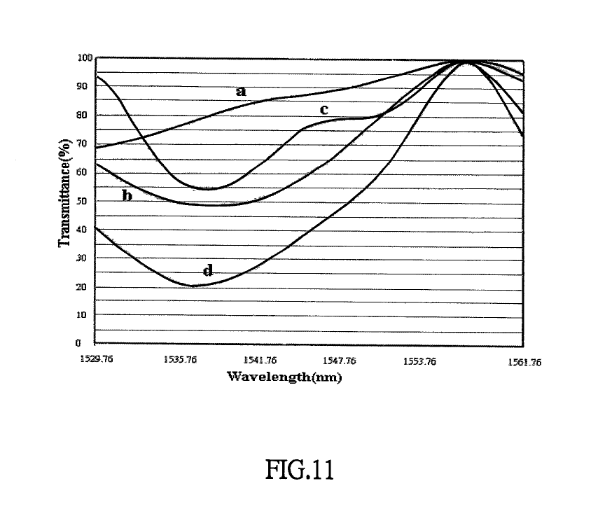

Please refer to FIGS. 6 and 8 for an embodiment of double-layered gain-flattening filter. Wherein the film stack A and the film stack B are coated on two different substrates, or the film stack A and the film stack B are coated on both sides of one substrate. The film stack A and the film stack B have structure of 73H76L41H at monitoring wavelength of 1730 nm and 1.18L (0.5HL0.5H)\hat{ }46 at monitoring wavelength of 1297 nm, respectively. H and L mean the optical thickness of the film is one fourth of the wavelength. Besides, the refractive indexes are 2.3 and 1.46, respectively. The configuration of the two pieces of double-layered gain-flattening filters in FIG. 6 shows one more additional degree of freedom than the configuration of the single piece of double-layered gain-flattening filter, so it allows angular adjustment of one filter to change the spectrum. The said film stack A and the said film stack B are combined to give a spectrum formed as the c spectrum in FIG. 9. The c spectrum and the spectrum in FIG. 1 can be mutually modulated to form the required gain-flattening spectrum for EDFA as shown in FIG. 4.

Again please refer to FIG. 10 for the target curve of another stack of gain-flattening filters. The target curve can be obtained by three filters (as shown in FIG. 7), wherein the filter a is 19H48L35H at monitoring wavelength of 152 nm, the filter b is 29H44L39H at monitoring wavelength of 1593 nm and declines by one degree, and the filter c is 71H72L43H at monitoring wavelength 1743 nm. d is the spectrum of a combination of filters a, b and c. Thus, the angular adjustment for the filter b is made by one-degree declination to change the spectrum of the whole set of filters. This further allows the match of the target curve for the gain-flattening filter in FIG. 10 by the spectrum from combination of the filter a, b and c. It is installed at the emitting end of the light source for EDFA with output gain-flattened spectrum, which facilitates the further application in optical communication.

To sum up, the stack of gain-flattening filters described in the method provided in the present invention for the original light source or the light source to modulate the light intensity is composed entirely of films in thickness of one fourth of the wavelength or mainly of films in thickness of one fourth of the wavelength plus few layers of non-one-fourth of the wavelength. Thus, the stack of gain-filtering filters enables the modulation of the light intensity for the original light source or the light source. Therefore, in the vacuum coating process, the wavelength formation parameter in a fixed number instead of a variable number is used as reference to control the film thickness. This relatively provides an easy control in manufacturing process and a significant increase in yield. In addition, such a formation mode of thin film on one side or double sides of a single piece causes less film stress. One or two pieces of such filters can be fine-tuned to approach the required filter waveform and obtain a perfect status of gain flattening. So it has great commercial feasibility.

What is claimed is:

1. A method for an original light source or a light source to modulate waveform intensity with a stack of gain-flattening filters including following procedures:
preparing said stack of gain-flattening filters made of more than two or three aligned single filters, each of said filter made by stacking on a substrate with several layers of optical thin films having different refractive indexes or stacking on both sides of a substrate with several different stacked films made of said optical thin films having different refractive indexes;
followed by modulating said waveform intensity with said stack of gain-flattening filters installed at an emitting end of said original light source or said light source, wherein an angle of each single filter can be adjusted to change spectrum of a whole set of filters so that said waveform intensity of said original light source or said light source is changeable or flattened when said emitted original light source or said light source is modulated with said stack of gain-flattening filters.

2. The method for a stack of gain-flattening filters to modulate waveform intensity of an original light source or a light source of claim 1, wherein said stack of filters is entirely formed by said layers with film thickness of one fourth of wavelength or mainly formed by said layers with film thickness of one fourth of said wavelength and few layers with film thickness of non-one-fourth of said wavelength.
